(19) United States
(12) Patent Application Publication
(10) Pub. No.: US 2025/0382221 A1
(43) Pub. Date: Dec. 18, 2025

(54) GLASS MATERIAL AND OPTICAL FIBER

(71) Applicant: SUMITOMO ELECTRIC INDUSTRIES, LTD., Osaka (JP)

(72) Inventors: Shin SATO, Osaka (JP); Takemi HASEGAWA, Osaka (JP); Shinji ISHIKAWA, Osaka (JP)

(21) Appl. No.: 18/879,074

(22) PCT Filed: Jun. 6, 2023
(86) PCT No.: PCT/JP2023/021031

§ 371 Date: Dec. 26, 2024

(30) Foreign Application Priority Data
Jun. 29, 2022 (JP) 2022-104474

(51) Int. Cl. C03C 13/04; C03C 3/076

(52) U.S. Cl. CPC C03C 13/045; C03C 3/076

(57) ABSTRACT

This glass material comprising silica glass contains at least one element selected from the Group 13 element group constituted by boron, aluminum, gallium, and indium. An optical fiber includes a core including silica-based glass and including at least one element selected from the element group consisting of boron, aluminum, gallium, and indium and a cladding including silica-based glass and surrounding the core.

### TECHNICAL FIELD

The present disclosure relates to a glass material and an optical fiber. This application claims priority based on Japanese Patent Application No. 2022-104474 filed on Jun. 29, 2022, and the entire contents of the Japanese patent application are incorporated herein by reference.

### BACKGROUND ART

Patent literature 1 discloses an optical fiber including a core doped with germanium. Germanium can increase the refractive index of the core.

### CITATION LIST

### Patent Literature

Patent literature 1: Japanese Unexamined Patent Application Publication No. 2013-218247

### SUMMARY OF INVENTION

A glass material according to an aspect of the present disclosure includes silica-based glass. The glass material includes at least one element selected from the group 13 element group consisting of boron, aluminum, gallium, and indium.

### BRIEF DESCRIPTION OF THE DRAWINGS

FIG. 1 is a cross-sectional view showing an optical fiber according to an embodiment.

FIG. 2 is a graph showing the relationship between the concentration ratio of aluminum to sodium and transmission loss.

FIG. 3 is a graph showing the relationship between the concentration ratio of aluminum to calcium and the transmission loss.

### DETAILED DESCRIPTION

### Problems to be Solved by Present Disclosure

When the concentration of doped elements (dopant) increases, the following problem may occur. That is, Rayleigh scattering due to composition fluctuation increases. In addition, the probability of contamination of impurities that may be contained in the dopant increases, and absorption in the ultraviolet and visible light regions due to impurities may occur. Further, the probability of distortion of the network structure of silica glass by doped elements increases, and glass defects are generated, which may result in an increase in absorption in the ultraviolet wavelength range. In this field, a glass material and an optical fiber having a high transmittance in a wide wavelength range are desired.

The object of the present disclosure is to provide a glass material and an optical fiber having a high transmittance in a wide wavelength range.

### Advantageous Effects of Present Disclosure

According to the present disclosure, the glass material and the optical fiber having a high transmittance in a wide wavelength range can be provided.

### Description of Embodiments of the Present Disclosure

First, embodiments of the present disclosure will be listed and described.
(1) A glass material according to an aspect of the present disclosure includes silica-based glass. The glass material includes at least one element selected from the group 13 element group consisting of boron, aluminum, gallium, and indium. Since the elements of the group 13 element group have a large refractive index change with respect to an addition amount, the concentration of a dopant for the refractive index change can be suppressed in this glass material. Thus, a high transmittance is achieved in a wide wavelength range.
(2) The glass material according to (1) may include at least one element selected from the alkali element group consisting of an alkali metal element and an alkaline-earth metal element. A concentration of the alkali metal element is represented by x, a concentration of the alkaline-earth metal element is represented by y, and x+2y may be 0.1 times to 10 times a concentration of the element of the group 13 element group. In this case, the element of the alkali element group aligns the valence of the element of the group 13 element group with the valence of silicon, and thus the distortion of the glass structure due to the group 13 element is suppressed. As a result, the occurrence of defects is suppressed, and the uniformity of the glass structure is promoted. Thus, a higher transmittance is achieved in a wide wavelength range.
(3) The glass material according to (1) may include at least one element selected from the alkali element group consisting of an alkali metal element and an alkaline-earth metal element. A concentration of the alkali metal element is represented by x, a concentration of the alkaline-earth metal element is represented by y, and x+2y may be 0.2 times to 5 times a concentration of the element of the group 13 element group. In this case, a much higher transmittance is achieved in a wide wavelength range.
(4) The glass material according to (1) may include at least one element selected from the alkali element group consisting of an alkali metal element and an alkaline-earth metal element. A concentration of the alkali metal element is represented by x, a concentration of the alkaline-earth metal element is represented by y, and x+2y may be 0.8 times to 1.2 times a concentration of the element of the group 13 element group. In this case, a particularly high transmittance in a wide wavelength range is achieved.
(5) In the glass material according to any one of (1) to (4), a relative refractive index difference based on a refractive index of pure silica glass may be 0.0% or more. When this glass material is used for forming a core, it is possible to suppress the excessive addition of a downdopant to a cladding.
(6) The glass material according to any one of (1) to (5) may include silica glass in a mass ratio of 50% or more. In this case, optical characteristics are prevented from being adversely affected.
(7) The glass material according to any one of (1) to (6) may include at least two elements selected from the group 13 element group. In this case, it is suppressed that a large amount of specific elements of the group 13 element group is included. Thus, a phase separated state of the substance into two components due to the increase in concentration can be suppressed.
(8) An optical fiber according to an aspect of the present disclosure includes a core including silica-based glass and including at least one element selected from the element group consisting of boron, aluminum, gallium, and indium, and a cladding including silica-based glass and surrounding the core. Since the elements of the group 13 element group have a large refractive index change with respect to an addition amount, the concentration of a dopant for the refractive index change can be suppressed in this optical fiber. Thus, a high transmittance is achieved in a wide wavelength range, and thus loss in a transmission wavelength band is reduced.

### Details of Embodiments of Present Disclosure

Specific examples of a glass material and an optical fiber of the present disclosure will be described below with reference to the drawings. It is noted that, the present invention is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

### (Glass Material)

A glass material according to an embodiment is, for example, an optical glass material. More specifically, the glass material is, for example, a glass material for an optical fiber, and is used for forming a core of the optical fiber. The glass material is formed of silica-based glass which contains silica glass as a main component. The glass material further contains another element other than silicon (Si) and oxygen (O) constituting silica glass.

The glass material includes at least one element of group 13 element group consisting of boron (B), aluminum (Al), gallium (Ga), and indium (In). The concentration of the element of the group 13 element group, that is, the group 13 element may be 10 ppm or more, 50 ppm or more, or 1000 ppm or more.

The glass material may include at least two types of elements of the group 13 element group, or may include three or more types of elements. When the glass material includes a plurality of group 13 elements, the concentration of each group 13 element required to realize a desired refractive index can be reduced. Thus, it is possible to suppress a state in which the compound of the group 13 element and the element present in the glass is phase-separated into two components with an increase in concentration.

When such a phase separation state occurs, light absorption and scattering occur at a phase interface, and as a result, the optical characteristics change. These phase states are greatly changed by the cooling rate in the glass manufacturing process and a slight temperature unevenness of, for example, about 10° C. Thus, the controllability of the optical characteristics is greatly deteriorated. Thus, it is very important to suppress the phase separation in the first place. In the glass material for optical fiber, when other substance phases are generated in the process of fiberization, the hardness in the glass becomes non-uniform, and as a result, the target fiber diameter and refractive index profile cannot be realized. Thus, it is important to suppress the concentration of each group 13 element in order to suppress a decrease in yield of optical fibers.

In the glass material for optical fiber, when other substance phases are generated in the process of fiberization, the hardness in the glass becomes non-uniform, and as a result, the target fiber diameter and refractive index profile cannot be realized. Thus, it is important to suppress the concentration of each group 13 element in order to suppress a decrease in yield of optical fibers.

When the phase separation of the additive substance occurs due to the addition of a plurality of types of elements, the optical characteristics are adversely affected as described above. Thus, the ratio of silica glass as the main component may be 50% or more, 90% or more, 95% or more, 98% or more, or 99% or more in mass ratio. Here, the mass ratio means a mass fraction.

A relative refractive index difference A of the glass material based on pure silica glass (SiO₂), that is, the refractive index of silica glass, may be 0.0% or more, 0.2% or more, or 0.3% or more. When such a glass material is used for forming the core, it is possible to suppress the excessive addition of a downdopant such as fluorine (F) to a cladding. Thus, it is possible to suppress an increase in transmission loss due to an increase in the concentration of the additive.

All of the group 13 elements are upper dopants, and are added in accordance with the refractive index of the glass material of interest. When a single element is added, that is, only one kind of group 13 element is added, in the case of aluminum, the mass ratio may be 10 ppm or more, 1000 ppm or more, or 10000 ppm or more. In the case of boron, the mass ratio may be 10 ppm or more, 300 ppm or more, or 3000 ppm or more. In the case of gallium and indium, the mass ratio may be 10 ppm or more, 50 ppm or more, or 100 ppm or more. Since the group 13 element has a large refractive index change with respect to the addition amount, the concentration of the dopant for the refractive index change can be suppressed. Thus, the occurrence of the problem associated with the increase in the concentration of the dopant is suppressed. That is, Rayleigh scattering due to composition fluctuation is suppressed. In addition, the probability of the contamination of impurities that may be contained in the dopant is reduced, and the occurrence of absorption in the ultraviolet and visible light regions due to impurities is suppressed. Further, the probability that the network structure of silica glass is distorted by doped elements is reduced, and glass defects are suppressed, and as a result, the absorption in the ultraviolet wavelength range is suppressed. Here, the mass ratio means a mass fraction.

The glass material may include at least one element of an alkali element group consisting of an alkali metal element and an alkaline-earth metal element. Examples of the alkali metal element include lithium (Li), sodium (Na), potassium (K), and rubidium (Rb). Examples of the alkaline-earth metal element include magnesium (Mg), calcium (Ca), strontium (Sr), and barium (Ba).

The element of the alkali element group has an effect of matching the valence of the group 13 element added to the glass material with the valence of silicon. By performing such valence matching, the distortion of the glass structure due to the group 13 element is suppressed. As a result, effects such as the suppression of occurrence of defects and the promotion of uniformity of the glass structure can be expected. Thus, as compared with glass materials, a wide wavelength range is expected in the optical glass application, and a reduction in transmission loss is expected in the optical fiber application.

When the total addition amount (molar concentration) of the alkali metal element is x and the total addition amount (molar concentration) of the alkaline-earth metal element is y, x+2y may be 0.1 times or more and 10 times or more, 0.2 times to 5 times, or 0.8 times or more and 1.2 times or more the concentration of the element of the group 13 element group. The concentration of the element of the alkali element group may be 10 ppm or more, 50 ppm or more, or 1000 ppm or more. The tetravalent of silicon can be compensated by the trivalent of the group 13 element and the monovalent of the alkali metal element. Thus, the addition amount of the alkali metal element ions may be larger than the addition amount of the alkaline-earth metal element ions.

The glass material may include a halogen element. Examples of the halogen element include fluorine (F), chlorine (Cl), bromine (Br), and iodine (I).

The synthesis of the glass material is realized by heating and diffusing a solid or a gas of an element to be added. In order to perform the valence matching as described above, the diffusion state of the element of the alkali element group and the diffusion state of the element of the group 13 may be equivalent. A diffusion rate varies depending on the element, and the diffusion coefficient of the element of the alkali element group is larger than the diffusion coefficient of the group 13 element. Thus, the diffusion addition of the element is performed after calculation so that the diffusion rate×time becomes approximately equal at the temperature at which the element is diffused and added.

### (Optical Fiber)

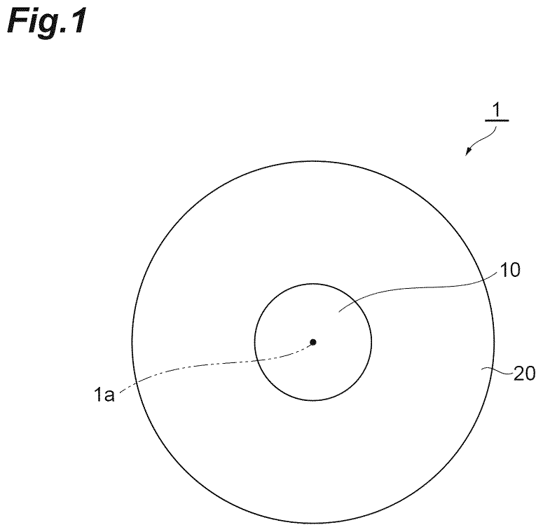

FIG. 1 is a cross-sectional view showing an optical fiber according to an embodiment. An optical fiber 1 according to the embodiment contains a core 10 extending along a central axis 1a and a cladding 20 surrounding core 10. Optical fiber 1 is formed using the glass material according to the embodiment. More specifically, core 10 is formed using the glass material according to the embodiment. Cladding 20 is formed of silica-based glass containing silica glass as a main component.

Table 1 shows the relationship between concentration ratio and transmission loss.

TABLE 1

| | Transmission loss | | Transmission loss |
|---|---|---|---|
| [Al]/[Na] | [dB/km] | [Al]/[Ca] | [dB/km] |
| 0.01 | 0.155 | 0.02 | 0.16 |
| 0.1 | 0.153 | 0.2 | 0.156 |
| 0.2 | 0.151 | 0.4 | 0.155 |
| 0.8 | 0.1495 | 1.6 | 0.153 |
| 1 | 0.148 | 2 | 0.151 |
| 1.2 | 0.15 | 2.4 | 0.153 |
| 5 | 0.153 | 10 | 0.156 |
| 10 | 0.156 | 20 | 0.161 |
| 50 | 0.163 | 125 | 0.182 |

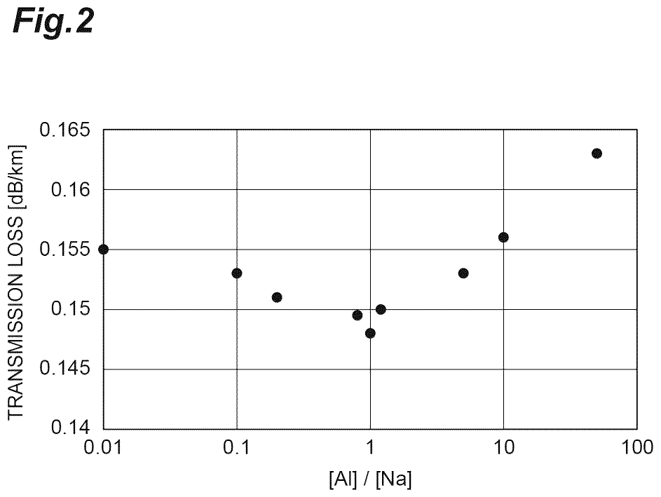

FIG. 2 is a graph showing the relationship between the concentration ratio of aluminum and sodium and the transmission loss. As shown in table 1 and FIG. 2, the transmission loss is lowest when the concentration ratio [Al]/[Na] of aluminum and sodium is one. As the concentration ratio [Al]/[Na] becomes lower than one, the transmission loss increases. As the concentration ratio [Al]/[Na] becomes higher than one, the transmission loss increases.

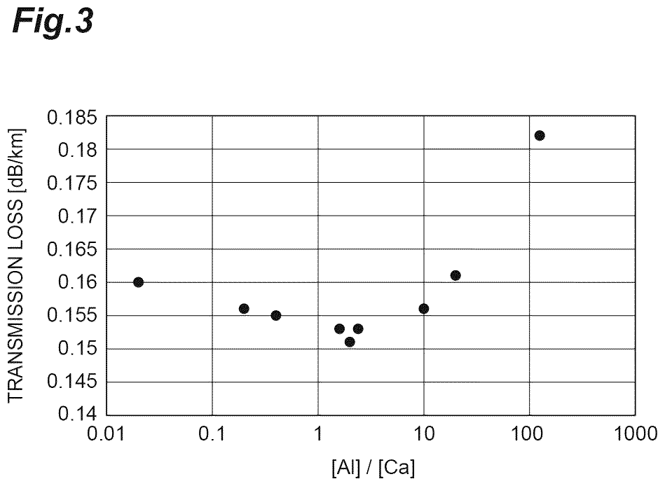

FIG. 3 is a graph showing the relationship between the concentration ratio of aluminum and calcium and the transmission loss. As shown in table 1 and FIG. 2, the transmission loss is lowest when the concentration ratio [Al]/[Ca] of aluminum and calcium is two. As the concentration ratio [Al]/[Ca] becomes lower than two, the transmission loss increases. As the concentration ratio [Al]/[Ca] becomes higher than two, the transmission loss increases.

The concentration of each element described above can be determined from measurement by an electron probe microanalyzer. The concentration is evaluated by analyzing the measurement result of the spectral intensity of the characteristic X-ray of each element. The concentration is determined from a calibration curve of the spectral intensity and the concentration prepared by using a plurality of standard samples having different concentrations. Measurement conditions are, for example, an acceleration voltage of 20 kV, a probe beam size of 1 μm or less, and a measurement interval of 100 nm.

Although the embodiments have been described, the present disclosure is not necessarily limited to the embodiments and variations described above, and many modifications are possible without departing from the gist thereof.

### REFERENCE SIGNS LIST

1 optical fiber
1a central axis
10 core
20 cladding

What is claimed is:

1. A glass material comprising silica-based glass,
wherein the glass material includes at least one element selected from the group 13 element group consisting of boron, aluminum, gallium, and indium.

2. The glass material according to claim 1, comprising at least one element selected from the alkali element group consisting of an alkali metal element and an alkaline-earth metal element,
wherein a concentration of the alkali metal element is represented by x, a concentration of the alkaline-earth metal element is represented by y, and x+2y is 0.1 times to 10 times a concentration of the element of the group 13 element group.

3. The glass material according to claim 1, comprising at least one element selected from the alkali element group consisting of an alkali metal element and an alkaline-earth metal element,
wherein a concentration of the alkali metal element is represented by x, a concentration of the alkaline-earth metal element is represented by y, and x+2y is 0.2 times to 5 times a concentration of the element of the group 13 element group.

4. The glass material according to claim 1, comprising at least one element selected from the alkali element group consisting of an alkali metal element and an alkaline-earth metal element,
wherein a concentration of the alkali metal element is represented by x, a concentration of the alkaline-earth metal element is represented by y, and x+2y is 0.8 times to 1.2 times a concentration of the element of the group 13 element group.

5. The glass material according to claim 1, wherein a relative refractive index difference based on a refractive index of pure silica glass is 0.0% or more.

6. The glass material according to claim 1, comprising silica glass in a mass ratio of 50% or more.

7. The glass material according to claim 1, comprising at least two elements selected from the group 13 element group.

8. An optical fiber comprising:
a core including silica-based glass and including at least one element selected from the element group consisting of boron, aluminum, gallium, and indium; and
a cladding including silica-based glass and surrounding the core.
